(19) United States
(12) Patent Application Publication
(10) Pub. No.: US 2005/0102654 A1
(43) Pub. Date: May 12, 2005

(54) System, method, and computer program product for testing program code

(75) Inventors: Barnaby Henderson, Milton (GB); Graham Hughes, Hills Road (GB)

Correspondence Address: DOCKET CLERK, DM/EDS, P.O. DRAWER 800889, DALLAS, TX, 75380, US

(73) Assignee: Electronic Data Systems Corporation, Plano, TX (US)

(21) Appl. No.: 10/706,875

(22) Filed: Nov. 12, 2003

(51) Int. Cl. G06F 9/44; G06F 7/00

(52) U.S. Cl. 717/126; 707/104.1

(57) ABSTRACT

A system, method, and computer program product for software code testing. By creating a coverage database that relates specific code portions to specific tests, the user or system can then determine which tests must be run for any code modification, and can run only those tests instead of the entire battery of tests.

### TECHNICAL FIELD OF THE INVENTION

The present invention is generally related to software development and testing.

### BACKGROUND OF THE INVENTION

Product testing requires a large number of tests to be run, and each test result must be stored. For example, one software product in development can require a set of 16,500 tests to be regularly run to ensure proper operation. These tests can take 15 hours to run using one test machine. If a developer makes a code change there is the distinct possibility that one or more of the 16,500 tests will regress. Experience has shown that if the developers do not run the tests over their changed code on one day, they are highly likely to have a significant number of regressions to deal with the next day, and product development and release schedules will suffer.

Of course, each test is time consuming, and detracts from the progress of the product development as a whole. Further, many of the tests performed analyze code segments that were not modified in the current build.

There is, therefore, a need in the art for a system, process and computer program product for performing efficient and change-specific code testing.

### SUMMARY OF THE INVENTION

A preferred embodiment provides a system, method, and computer program product for software code testing. By creating a coverage database that relates specific code portions to specific tests, the user or system can then determine which tests must be run for any code modification, and can run only those tests instead of the entire battery of tests.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 depicts a block diagram of a data processing system in which a preferred embodiment can be implemented;

FIG. 2 depicts a block diagram illustrating the relationship between the three tables in each coverage database, in accordance with an embodiment of the present invention; and

FIG. 3 depicts a flowchart of a process in accordance with a preferred embodiment.

### DETAILED DESCRIPTION OF THE INVENTION

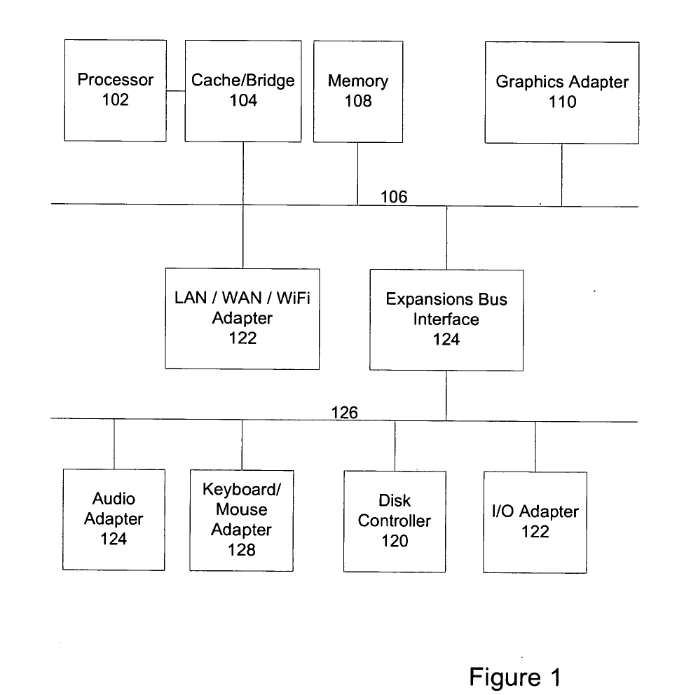

FIGS. 1 through 3, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device. The numerous innovative teachings of the present application will be described with particular reference to the presently preferred embodiment.

A preferred embodiment provides a system, method, and computer program product for software code testing. By creating a coverage database that relates specific code portions to specific tests, the user or system can then determine which tests must be run for any code modification, and can run only those tests instead of the entire battery of tests.

FIG. 1 depicts a block diagram of a data processing system in which a preferred embodiment can be implemented. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular. For example, other peripheral devices, such as an optical disk drive and the like, also may be used in addition or in place of the hardware depicted. The depicted example is provided for the purpose of explanation only and is not meant to imply architectural limitations with respect to the present invention.

A data processing system in accordance with a preferred embodiment of the present invention includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present invention as described.

One embodiment of the present invention uses a coverage analysis tool in an unusual manner. Normally, coverage analysis tools are used to determine which areas of code have not been tested by the test set, in order to guide the process of writing more tests. This is to ensure that eventually all code is tested.

According to the preferred embodiment, a coverage analysis tool is used to create a set of coverage databases that store which tests in the test set cover which areas of code. As a result, if a developer changes a piece of code, they or the system can search the databases to find the list of tests that cover that code, and can run only this subset of tests. This means that tests that would never exercise the altered code will not be run, and the time and processing power these runs would have taken up are saved. Typically, a developer's test run now takes minutes rather than hours or days to complete. One commercially available coverage analysis tool, capable of being utilized according to this embodiment, is Rational Pure Coverage.

The system is presented through a web-based interface. The developer can enter the name or names of files that have been altered, and/or the name or names of functions that have been altered into a web form. On submission the system searches the coverage databases and produces a list of all the known tests that, when run, cover code in the given files or function. This list is then handed to the test harness in order to run the tests. Within minutes the regression results are returned to the developer, by email or otherwise, who can decide whether or not to check the changed code back into the main source tree.

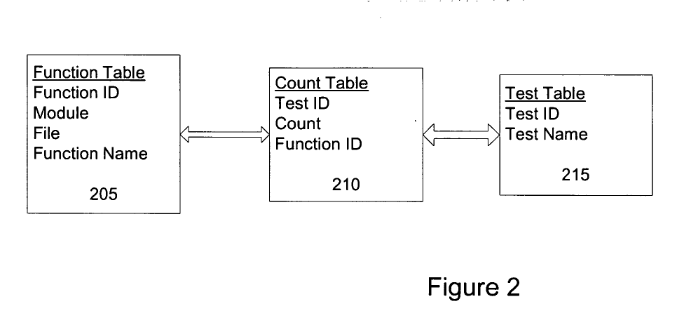

FIG. 2 shows the relationship between the three tables in each coverage database. Here, the function table 205 contains an entry for each function, linking the function name to the file in which the function is defined and the module to which it belongs, and provides each function with a unique identification number.

The test table 215 provides each test with a unique identification number.

The coverage analysis tool data is used to construct the count table 210, which links each test ID to the function IDs of the functions that the test exercises, and the number of times that the test calls the function is also recorded under a column headed “Count”.

As the code changes may change the coverage data, the data is regenerated on a rolling basis for the different regimes and test subsets.

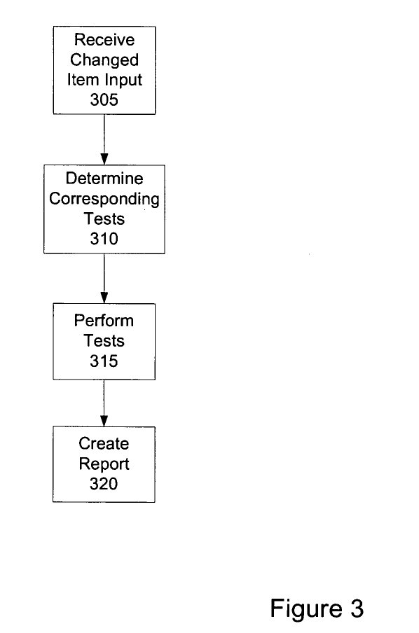

FIG. 3 depicts a flowchart of a process in accordance with a preferred embodiment. Here, the system first receives a changed item identifier (step 305). The changed item can be a file name, a function name, or some other identifier of a file, function, or routine that has been changed or for some other reason should be tested.

Optionally, multiple changed item identifiers can be received at this point. In this case, all of the steps described preferably will operate on all the changed item identifiers. Alternately, a changed item identifier may identify multiple files, functions, or routines.

Next, the system will look up the changed item identifier in a table to database to determine the corresponding test or tests (step 310). These tests are those that specifically test the routine, function, or file selected, preferably without including any additional tests that do not test the selected routine, function, or file.

Next, the system will perform the test or tests identified to test the program code corresponding to the selected routine, function, or file (step 315).

The system will then produce a report of test results (step 320), and will optionally display the report to the user.

Those of skill in the art will recognize modifications, variations, and improvements that can be made to the disclosed embodiments. For example, one alternate embodiment includes a queuing system that allows developers to submit which functions they want to see retested to a queue, and the system handles each submission in turn. Another embodiment also includes a ranking system that allows jobs submitted later to take precedence.

Those skilled in the art will recognize that, for simplicity and clarity, the full structure and operation of all data processing systems suitable for use with the present invention is not being depicted or described herein. Instead, only so much of a data processing system as is unique to the present invention or necessary for an understanding of the present invention is depicted and described. The remainder of the construction and operation of data processing system 100 may conform to any of the various current implementations and practices known in the art.

It is important to note that while the present invention has been described in the context of a fully functional system, those skilled in the art will appreciate that at least portions of the mechanism of the present invention are capable of being distributed in the form of a instructions contained within a machine usable medium in any of a variety of forms, and that the present invention applies equally regardless of the particular type of instruction or signal bearing medium utilized to actually carry out the distribution. Examples of machine usable mediums include: nonvolatile, hard-coded type mediums such as read only memories (ROMs) or erasable, electrically programmable read only memories (EEPROMs), user-recordable type mediums such as floppy disks, hard disk drives and compact disk read only memories (CD-ROMs) or digital versatile disks (DVDs), and transmission type mediums such as digital and analog communication links.

Although an exemplary embodiment of the present invention has been described in detail, those skilled in the art will understand that various changes, substitutions, variations, and improvements of the invention disclosed herein may be made without departing from the spirit and scope of the invention in its broadest form.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC §112 unless the exact words “means for” are followed by a participle.

1. A method for storing testing code, comprising:
receiving a changed item identifier;
determining at least one test corresponding to the changed item identifier;
testing program code corresponding to the changed item identifier using the at least one test; and
creating a report according to the results of the testing.

2. The method of claim 1, wherein the changed item identifier corresponds to a file.

3. The method of claim 1, further comprising providing a database having multiple changed item identifier records, each changed item identifier record corresponding to at least one test.

4. The method of claim 1, wherein the at least one test is a program code validation test.

5. A data processing system having at least a processor and accessible memory, comprising:
means for receiving a changed item identifier;
means for determining at least one test corresponding to the changed item identifier;
means for testing program code corresponding to the changed item identifier using the at least one test; and
means for creating a report according to the results of the testing.

6. The data processing system of claim 5, wherein the changed item identifier corresponds to a file.

7. The data processing system of claim 5, further comprising a database having multiple changed item identifier records, each changed item identifier record corresponding to at least one test.

8. The data processing system of claim 5, wherein the at least one test is a program code validation test.

9. A computer program product tangibly embodied in a machine-readable medium, comprising:
instructions for receiving a changed item identifier;
instructions for determining at least one test corresponding to the changed item identifier;
instructions for testing program code corresponding to the changed item identifier using the at least one test; and
instructions for creating a report according to the results of the testing.

10. The computer program product of claim 9, wherein the changed item identifier corresponds to a file.

11. The computer program product of claim 9, further comprising instructions for providing a database having multiple changed item identifier records, each changed item identifier record corresponding to at least one test.

12. The computer program product claim 9, wherein the at least one test is a program code validation test.
